(19) United States
(12) Patent Application Publication
(10) Pub. No.: US 2005/0019600 A1
(43) Pub. Date: Jan. 27, 2005

(54) Method for manufacturing a highly weather resistant colored steel plate

(75) Inventors: Jang Hyun Choi, Pusan (KR); Sung Su Jun, Pusan (KR); Woon Young Lee, Pusan (KR); Sung Kwon An, Pusan (KR)

Correspondence Address: SQUIRE, SANDERS & DEMPSEY L.L.P, 600 HANSEN WAY, PALO ALTO, CA, 94304-1043, US

(73) Assignee: UNION STEEL MANUFACTURING CO., LTD., Pusan (KR)

(21) Appl. No.: 10/923,418

(22) Filed: Aug. 20, 2004

Related U.S. Application Data
(62) Division of application No. 10/661,222, filed on Sep. 12, 2003.

(30) Foreign Application Priority Data
Sep. 19, 2002 (KR) 10-2002-0057229

(51) Int. Cl. B32B 15/08

(52) U.S. Cl. 428/626; 428/659; 428/632

(57) ABSTRACT

Disclosed herein is a highly weather resistant colored steel plate which comprises a steel plate as a substrate, a zinc- or zinc alloy-plated layer formed on the steel plate, a layer formed on the zinc- or zinc alloy-plated layer and pretreated with chromate or non-chromate, and a highly weather resistant film formed on the chromate or non-chromate layer, wherein the highly weather resistant film includes a polyester-based primer coated onto the chromate or non-chromate layer and a polyester top coat coated onto the polyester-based primer, the top coat being produced from a mixture of a main resin obtained by reacting an oil-free polyester-modified resin and a polyisocyanate compound, a melamine resin as a crosslinking agent, and other additives. The physical properties of the highly weather resistant colored steel plate are excellent in terms of functional characteristics such as weather resistance and UV resistance, compared to those of conventional modified (RMP), highly weather resistant (HDP) and silicone-modified (SMP) colored steel plates. In addition, the highly weather resistant colored steel plate is inexpensive relative to conventional fluorine resin steel plates, shows much less influence by colors, and has physical properties equivalent to the fluorine resin steel plates.

### BACKGROUND OF THE INVENTION

1. Field of the Invention

The present invention relates to a colored steel plate in which a highly weather resistant film is formed on a steel plate, and a method for manufacturing the colored steel plate. More particularly, the present invention relates to a colored steel plate manufactured by electroplating or melt-plating zinc or a zinc alloy on a substrate, treating the zinc- or zinc alloy-plated steel plate with a coating-type chromate or non-chromate to prevent the corrosion of the plated steel plate and improve the adhesion between the plated steel plate and a film, and forming a film having excellent fouling resistance, acid resistance and weather resistance thereon, and a method for manufacturing the colored steel plate.

2. Description of the Related Art

Buildings in which colored PCM steel plates are used as exterior building materials are classified into high-rise buildings using high-level materials and low-rise buildings using low-level materials. Since the high-rise buildings must be durable for a long period of time, colored steel plates on which a highly weather resistant fluorine resin paint is applied are mainly used. On the contrary, in the case of the low-rise buildings, RMP colored steel plates on which a general polyester paint is applied are used. However, since these low-level polyester colored steel plates have a relatively short color retention period, the appearance of buildings is worsened and thus consumer's complaints gradually increase, in particular, in regions where exposure to UV light due to the depleted ozone layer is serious, e.g., Southeast Asia and equatorial regions where sunlight irradiation and ambient temperature are high. Above all, dark blue, dark green and red colored steel plates which are mainly used as roof materials are easily decolorized and this causes many problems. Although conventional weather resistant steel plates (hereinafter, referred to as “HDP steel plates”) are modified to further reinforce weather resistance, the reinforced weather resistant effect is unsatisfactory for dark colors.

Furthermore, most highly weather resistant fluorine resin colored steel plates (hereinafter, referred to as “PVDF steel plates”) are expensive and limited in the choice of colors due to low transparency of the fluorine contained in the steel plates. Accordingly, these PVDF steel plates cannot satisfy the consumer's diverse needs for light colors.

### SUMMARY OF THE INVENTION

Therefore, the present invention has been made in view of the above problems, and it is an object of the present invention to provide a highly weather resistant colored steel plate (hereinafter, referred to as a “WDP steel plate”) which has excellent weather resistance, is inexpensive relative to fluorine resin steel plates, has much less influence on the colors and has physical properties equivalent to the fluorine resin steel plates.

In order to accomplish the above object of the present invention, there is provided a highly weather resistant colored steel plate which comprises a steel plate as a substrate, a zinc- or zinc alloy-plated layer formed on the steel plate, a layer formed on the zinc- or zinc alloy-plated layer and pretreated with chromate or non-chromate, and a highly weather resistant film formed on the chromate or non-chromate layer, wherein the highly weather resistant film includes a polyester-based primer coated onto the chromate or non-chromate layer and a polyester top coat coated onto the polyester-based primer, the top coat being produced from a mixture of a main resin obtained by reacting an oil-free polyester-modified resin and a polyisocyanate compound, a melamine resin as a crosslinking agent, and other additives.

In accordance with one aspect of the present invention, there is provided a method for manufacturing a highly weather resistant colored steel plate which comprises the steps of: coating chromate or non-chromate onto a zinc- or zinc alloy-plated layer in the form of a thin film at a line speed of 60-120 mpm using a roll coating process, and drying the chromate or non-chromate layer at 60˜140° C. to form a pretreated layer having a density of 20-80 mg/m²; and roll coating a highly weather resistant paint consisting of a colored or colored transparent epoxy-modified or polyester-modified primer and a colored or colored transparent polyester-based top coat, onto the pretreated layer, and heating and drying the roll coated structure at a PMT of 190-240° C. to form a highly weather resistant film.

### BRIEF DESCRIPTION OF THE DRAWINGS

The above and other objects, features and other advantages of the present invention will be more clearly understood from the following detailed description taken in conjunction with the accompanying drawing, in which:

FIG. 1 is a cross-sectional view of a highly weather resistant colored steel plate according to the present invention.

### DESCRIPTION OF THE PREFERRED EMBODIMENTS

Hereinafter, other features and effects of the present invention will be further explained in more detail with reference to the accompanying drawings.

A highly weather resistant colored steel plate of the present invention comprises a steel plate 1 as a substrate, a zinc- or zinc alloy-plated layer 2 having a thickness of 5-25 μm formed by electroplating or melt-plating zinc or a zinc-alloy on the steel plate 1, a pretreated layer 3 having a density of 20˜80 mg/m² formed by treating the zinc- or zinc alloy-plated layer 2 with chromate or non-chromate in the form of a thin film at a line speed of 60-120 mpm using a roll coating process and drying the chromate or non-chromate layer at 60˜140° C., and a highly weather resistant film 10 including a polyester-based primer 4 coated onto the chromate or non-chromate layer and a polyester top coat 5 coated onto the polyester-based primer 4. The polyester-based primer 4 has a dry film thickness (D.F.T) of 4˜7 μm, and preferably 5 μm. The polyester top coat 5 has a dry film thickness (D.F.T) of 15˜22 μm. When the thickness of the polyester top coat 5 is less than 15 μm, weather resistance is degraded with the passage of time. When the thickness of the polyester top coat 5 exceeds 22 μm, it becomes economically disadvantageous. Accordingly, the polyester top coat 5 is preferably roll-coated so as to have a thickness of 18˜20 μm, and then the roll-coated steel plate is heated and dried in a dry oven at a PMT (peak metal temperature) of 190-240° C.

At this time, a highly weather resistant PCM paint coated onto the plated steel plate consists of a polyester resin as a main resin and a melamine resin as a curing resin. The polyester resin increases Tg so as to show excellent weather resistance and corrosion resistance, and improves poor flowability of a paint, one of the drawbacks of a paint, thereby exhibiting a smooth thixotropic property and flexibility upon coating. The melamine resin is a curing agent capable of imparting fouling resistance, solvent resistance and film hardness, and is crosslinked with the polyester resin to maximize the weather resistance of the film. In addition, the melamine resin makes the film compact and thus substantially prevents foreign environmental contaminants from penetrating the film, thereby improving corrosion resistance and resistance to acids such as acid present in acid rain. In other words, the highly weather resistant PCM paint shows satisfactory weather resistance, fouling resistance against circumferential contaminating factors, corrosion resistance and acid resistance.

In this regard, the paint is generally formulated as follows.

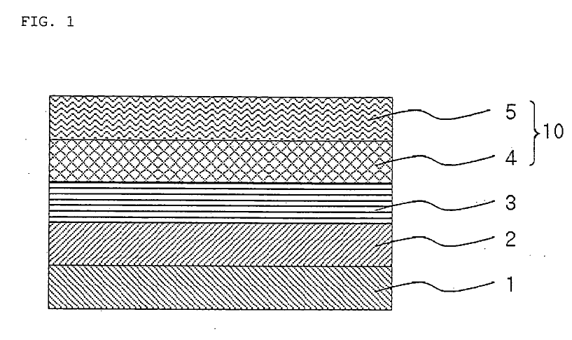

Referring to FIG. 1, a top coat binder constituting a polyester top coat 5 includes an oil-free polyester-modified resin having hydroxyl groups and preferably a resin obtained by reacting the oil-free polyester-modified resin with a common non-yellowing type polyisocyanate compound, as a main resin.

The polyisocyanate reacts some OH groups substituted in a polyester main chain to form urethane bonds, and serves to assist in imparting physical properties such as weather resistance, UV resistance, corrosion resistance and the like to the resin itself. Suitable examples of the polyisocyanate usable in the present invention include hexamethylene diisocyanate (HMDI), isophorone diisocyanate (IPDI), xylene diisocyanate, 2,4,6-triisocyanatetoluene and other compounds having properties similar thereto. BL317523 and DEDMODUR 1 (Bayer) as the HMDI, and LUXATE (Lyondell) as the IPDI are commercially available as the polyisocyanate compound.

The polyester resin as a main resin has a number average molecular weight of 1,000˜9,000, a glass transition temperature (Tg) of −5-45° C., and an OH number of 15˜150. Within these ranges, the film shows optimum physical properties such as flexibility, hardness, solvent resistance, fouling resistance and the like. The glass transition temperature (Tg) and the number average molecular weight of the polyester resin are determined by differential thermal analysis (DTA) and gel permeation chromatography (GPC), respectively.

In accordance with the present invention, the oil-free polyester-modified resin is obtained by the reaction of a polybasic acid and a polyhydric alcohol. As the polybasic acid, alicyclic acids, phthalic anhydride, isophthalic acid, terephthalic acid, succinic acid, adipic acid, pumaric acid, maleic anhydride, tetrahydrophthalic anhydride, hexahydro phthalic anhydride and derivatives thereof can be used. However, when an excess of a monomer having double bonds therein, e.g., isophthalic acid, is used, the weather resistance of the film is poor. Accordingly, it is preferable to use a mixture with a linear acid, e.g., an alicyclic acid, containing no benzene ring. Recommended alicyclic acids are 1,4-cyclohexane dicarboxylic acid (CHDA), hexahydrophthalic anhydride (HHPA), ethylhexahydrophthalic anhydride (MHHPA), etc.

As the polyhydric alcohol, ethyleneglycol, propyleneglycol, diethyleneglycol, butanediol, neopentylglycol, 3-methylpentanediol, 1,4-hexanediol and 1,6-hexanediol, etc. can be used. If an excess of monomer such as EG (ethylene glycol) is used, the film is susceptible to UV light and thus tends to be hydrolyzed. Accordingly, neopentyl glycol (NPG), etc. are suitable as the polyhydric alcohol in terms of weather resistance.

The non-yellowing type polyisocyanate, one component of the main resin obtained by reacting the oil-free polyester-modified resin and the non-yellowing type polyisocyanate, is preferably present in an amount of 5-30 parts by weight based on the solid of the main resin. When the content of the non-yellowing type polyisocyanate is less than 5 parts by weight based on the main resin, satisfactory weather resistance, UV resistance and corrosion resistance cannot be obtained. When the content of the non-yellowing type polyisocyanate exceeds 30 parts by weight, the molecular weight of the main resin becomes high and thus the flowability of the resin appreciably drops, thus make it unsuitable as a paint resin.

On the other hand, the main resin obtained by reacting the oil-free polyester-modified resin and the non-yellowing type polyisocyanate is preferably present in an amount of 25-50 parts by weight, based on the total weight of the composition of the top coat 5. When the content of the main resin is less than 25 parts by weight, the flexibility, impact resistance and weather resistance of the film are considerably decreased. When the content of the main resin exceeds 50 parts by weight, the fouling resistance, solvent resistance and hardness of the film are drastically reduced.

The melamine resin used in the present invention is preferably a methoxy melamine or a mixture of the methoxy melamine and a butoxy melamine having a molecular weight of 300-1000. If the butoxy melamine alone, or the mixture of the methoxy melamine and the butoxy melamine is used, the compatibility with the polyester resin drastically decreases and thus the melamine is transferred to the upper portion of the paint. This transfer improves the fouling resistance of the film, but causes decreased gloss and poor processibility of the film.

The melamine resin is preferably present in an amount of 4-10 parts by weight, based on the total weight of the composition of the top coat 5. When the content of the melamine resin is less than 4 parts by weight, the fouling resistance and solvent resistance of the film are drastically decrased. When the content of the melamine resin exceeds 10 parts by weight, the flexibility and impact resistance of the film is undesirably decreased.

As commercially available products capable of serving as the melamine resin, there are RESIMINE 755, RESIMINE 757 and RESIMINE 751 (Solutia), CYMEL 1168, CYMEL 1170 and CYMEL 232 (Cytel), etc., and preferably CYMEL 1168 (solid content: 95%) as the mixture of methoxy melamine and butoxy melamine.

As a curing accelerator which promotes the crosslinking between the polyester as a main resin and the melamine as a crosslinking resin to increase the compactness of the film, heat-dissociable compounds such as an amine-masking p-toluene sulfonic acid, dinonylnaphthalene sulfonic acid, etc. can be used. The amine may be a common primary, secondary or tertiary amine, and preferably secondary amine.

This is because the primary amine causes changes in the color of the film, e.g., yellowing, and the tertiary amine causes surface contraction of the film. In addition to the amine, an epoxy masking sulfonic acid or organic resin masking sulfonic acid can be used. When the amount of this compound is deficient, the curing of the film may be insufficient depending on working conditions. When an excess of the compound is used, the curing of the film occurs too rapidly, causing the popping of the film upon coating or the contraction of the film. Among commercially available secondary amine products, Nacure 1953 and Nacure 1419 (King), dinonylnaphthalene sulfonic acid (DNNSA)-based amine compounds, are recommended.

When the content of the amine, i.e., curing accelerator, is less than 1 part by weight based on the weight of the composition of the top coat 5, the curing of the film may be insufficient depending on working conditions. When the content of the amine exceeds 6 parts by weight, the curing of the film occurs too rapidly, causing the popping of the film upon coating and the contraction of the film. Further, the amine may remain on the cured film, resulting in poor weather resistance of the film. Accordingly, the content of the curing accelerator is preferably within the range of 1-6 parts by weight, based on the composition of the top coat 5.

Since the polyester paint composition contains polyester having excellent weather resistance, it can be used as a colored transparent paint containing no pigment and can form a coating film using an organic or inorganic pigment. The pigment usable in the colored paints is preferably one capable of imparting heat resistance and chemical resistance suitable for PCM paints. Particles constituting the pigment must be considered. Examples of the pigment include cyanine blue, titanium oxide white, iron oxide red, carbon black, chromium yellow, carbon black, etc. As an extender, talc, clay, silica, aluminum oxides, etc. can be used.

The kind of the pigment and amount thereof depends on the desired color of the paint. The present invention is characterized in that the rheology of the resin is appropriately maintained to be constant so as to have excellent weather resistance and corrosion resistance, etc., increase a glass transition temperature (Tg) intrinsic to the resin and maintain good processibility. For these purposes, the amount of the pigment, particularly organic pigment, needs to be limited. It is common to classify the organic pigment in accordance with oil absorption of the organic pigment rather than components contained in the organic pigment. When the oil absorption of a pigment is 80 or more, the pigment is classified as an organic pigment. The content of the organic pigment is controlled to be 5 parts by weight or less, preferably 3 parts by weight or less, based on the composition of the top coat 5. In addition, in the case of the inorganic pigment, 39 parts by weight or less is preferred.

As a dispersant for improving the coating processibility in the present invention, products in which the rheology control of the paint is appropriately adjusted are required. Examples of the dispersant used in the present invention include P104, P104(S) (BYK), DISPER BYK130, 160, 170, 173, ANTITERRA-U, NUOSPERSE 657, etc.; EFCA-776, EFCA-4050, EFCA-4063, EFCA-4051, etc. (EFCA); CFC-604 (TEGO); and DISPALON 501, 203, 230, etc. (DISPALON).

Any dispersant that does not damage the rheology can be used. If a dispersant not damaging the rheology is used alone, there is a risk of color separation of the paint and sedimentation of the pigment. For these reasons, a polymeric dispersant in an appropriate amount is further added.

The amount of the dispersant generally depends on the content of the pigment. Productivity and compatibility of the paint should also be considered. The amount of the dispersant is commonly 0.5-40% of the amount of the pigment. In the case of the organic, pigment, the percentage is high. On the contrary, in the case of the inorganic pigment, the percentage is low. For example, the amount of the dispersant is preferably 10-20% of the amount of the organic pigment; whereas the amount of the dispersant is preferably 0.5-2% of the amount of the inorganic pigment.

As a material for changing the rheology of the paint, a rheology control agent is used. Exemplary rheology control agents include china clay products, e.g., BENTONE #38, BENTONE. #34, BENTONE #27 (TROYKYD), HUMED SILICA products, e.g., AEROSIL R972, #200, #380 (DEGGUSA), HPA-15 (AVECIA), PESA-1000 (ALKENZ CHEMICAL), etc. More preferable rheology control agents are HPA-15 (AVECIA) and PESA-1000 (ALKENZ CHEMICAL). The amount of the rheology control agent used is within the range of 2-5 parts by weight, based on the composition of the top coat 5. When the amount of the rheology control agent exceeds 5 parts by weight, it is economically disadvantageous and physical properties, e.g., water proofing, are deteriorated. When the amount of the rheology control agent is less than 2 parts by weight, a minimal rheology controlling effect is exhibited.

A solvent for the top coat paint for smoothing the surface of the top coat and preventing the occurrence of roll marks is selected from hydrocarbons and ester-based compounds.

The top coat paint preferably has a composition shown in Table 1 below.

TABLE 1

| | Components | Content (wt %) |
|---|---|---|
| Resin | POLYESTER RESIN | 25˜50 |
| | MELAMINE RESIN | 4˜10 |
| Pigment | ORGANIC PIGMENT | 0.5˜5 |
| | INORGANIC PIGMENT | 0˜39 |
| Additive | Dispersant | 0.5˜40 |
| | (based on the pigment) | |
| | Rheology control agent | 2˜5 |
| | Curing accelerator | 1˜6 |
| | (including auxiliary accelerator) | |
| Solvent | HYDROCARBON-BASED | 15˜25 |
| | ESTER-BASED | 15˜25 |

Hereinafter, the choice of a primer constituting the polyester-based-primer 4 will-be explained.

The primer for the adhesion between each material (the top coat and the plated steel plate) in the present invention includes epoxy-based primers, polyester-based primers, acryl-based primers and modified primers thereof. EJ-2751 (Korea Chemical Co., Ltd) is commercially available as the polyester-based primer, EJ-2753 (Korea Chemical Co., Ltd) is commercially available as the epoxy-modified primer and TP-1865 (fluorine acryl) is commercially available as the acryl-based primer.

In a preferred example of the present invention, the polyester-based primer is used. The primer exhibits basic corrosion resistance and adhesion between the top coat and the plated steel plate and functions as a buffer layer between the top coat and the plated steel plate due to high elongation. Accordingly, cracks occurring during processing cannot reach the top coat. Examples of the pigment include, but are not limited to, organic and inorganic pigments for PCM paints.

The application of the paint to the zinc- or zinc alloy-plated steel plate led to excellent physical properties such as weather resistance and UV resistance, compared to conventional PCM steel plates. Other physical properties turned out to be superior to those of conventional steel plates.

Specific Examples will be described below.

Dimension of a test piece and coating conditions used in the following Examples, and comparative paints are as follows.
1. Composition of a weather resistant film 10
   Main resin: 28 parts by weight
   Melamine resin: 4 parts by weight
   Pigment: 38 parts by weight
   Dispersant: 3 parts by weight
   Rheology control agent: 2 parts-by weight
   Curing accelerator: 1 part by weight
   Solvent: 24 parts by weight
2. Test conditions
1) Dimension of a test piece and coating conditions
   Dimension of a coil: W (width) 1219×T (thickness) 0.5 mm GI (galvannealed steel plate)
Thickness of a dry film: Primer (5˜6 μm) and top coat (18˜20 μm)
Surface gloss 60°: Mat gloss (25˜30%)
Operational viscosity of the primer (25, based on #4 Ford cup) 40 seconds
Operational viscosity of the top coat (25, based on #4 Ford cup) 60 seconds
Roll coating process: Natural reverse (2ROLL nature reverse)
Primer: EJ-2751 (Korea Chemical Co., Ltd)
2) Operational conditions
   PMT: Top coat 232/primer 224
   Line speed: 120 mpm
3) Comparative 4 red paints
   RMP (General modified polyester): FJ2610 (Korea Chemical Co., Ltd)
   HDP (Highly weather resistant polyester): KP1578 (Construction Chemicals)
SMP (Silicone-modified polyester): KP7719-2 (Construction Chemicals)

PVDF (Fluorine acryl): YJ2442 (Korea Chemical Co., Ltd)

Test pieces of the paints manufactured at optimum drying conditions (PMT) in labor sites were compared with each other.

The thickness of the dry films of the test pieces was adjusted to the thickness shown above.

The physical properties of the highly weather resistant film and the comparative products were measured. The results are shown in Table 2 below.

TABLE 2

| | | | RMP | HDP | SMP | PVDF | WDP |
|---|---|---|---|---|---|---|---|
| 1. Processability | | | ◯ | ◯ | ◯ | ◯ | ◯ |
| 2. Roll mark | | | ◯ | ◯ | ◯ | ◯ | ◯ |
| 3. Gloss (60°) | | | 25 | 26.1 | 26.6 | 27.3 | 27.8 |
| 4. Solvent resistance (times) | | | 100 | 100 | 100 | 100 | 100 |
| 5. Pencil roughness | | | H | H | H | H | H |
| 6. Heating resistance | | | 100/100 | 100/100 | 100/100 | 100/100 | 100/100 |
| 7. Processability | | T- | 2T | 2T | 2T | 2T | 2T |
| | | bending | | | | | |
| | | S- | Δ | ◯ | ◯ | ◯ | ◯ |
| | | cupping | | | | | |
| 8. Adhesion | | | 100/100 | 100/100 | 100/100 | 100/100 | 100/100 |
| 9. Imapct resistance | | | Δ | ◯ | ◯ | ◯ | ◯ |
| 10. Chemical | | 5% NaOH | ◯ | ◯ | ◯ | ◯ | ◯ |
| resistance | | 5% HCl | ◯ | ◯ | ◯ | ◯ | ◯ |
| 12. Corrosion resistance | | | ◯ | ◯ | ◯ | ◯ | ◯ |
| (1000 hr) | | | | | | | |
| 13. UV | Gloss | 500 hr | 18.14 | 36.9 | 72.7 | 100 | 100.5 |
| resistance | maintenance | | | | | | |
| | (%) | | | | | | |
| | E | 100 hr | 6.9 | 20.2 | 30.6 | 100.8 | 97.8 |
| | | 500 hr | 1.55 | 1.43 | 1.08 | 0.12 | 0.43 |
| | | 1000 hr | 4.61 | 2.16 | 1.77 | 0.39 | 1.05 |
| 14. | Gloss | 500 hr | 29.4 | 46.67 | 75.20 | 78.23 | 80.02 |
| Weather | maintenance | | | | | | |
| resistance | (%) | | | | | | |
| | E | 1000 hr | 17.9 | 28.11 | 68.36 | 77.82 | 75.21 |
| | | 500 hr | 1.98 | 1.44 | 0.64 | 0.30 | 0.35 |
| | | 1000 hr | 3.64 | 2.34 | 1.17 | 0.44 | 0.46 |

◯: Good, Δ: Average, X: Poor

1. Processibility: Pick up property upon roll coating in a labor site
2. Roll mark: Marks on the coated surface upon roll coating
3. Gloss: Initial value measured by GLOSS METER (60°)
4. Solvent resistance: M.E.K Rubbing
5. Pencil hardness: Result of scratch resistance test using “Unipencil” (Mitsubishi, Japan)
6. Heating resistance: 100° C.×3 hrs, taping after cross-cutting at an interval of 1 mm, number remaining after peeling
7. Processibility: T bending, state of cracks after square cupping
8. Adhesion: 6 mm cross cut
9. Impact resistance: ½φ1 kg×50 cm
10. Chemical resistance: color difference of a test piece before and after dipping in 5% NaOH and HCl solution for 24 hours, respectively
11. Corrosion resistance: S.S.T (salt spray test) 35° C. 5% NaCl, 1000 hr
12. UV resistance: (Q.U.V-B: Light source UV-B 281-315 nm)
   :UV irradiation at 50° C.×8 hrs and 45° C.×8 hrs and then repetition of the cycle
   Gloss after 500/1000 hrs (relative to initial value (%)), ΔE value measurement
13. Weather resistance (Light source: Xenon arc)
   :UV irradiation at 63° C.×humidity (50%)×5 hrs and at 63° C.×humidity (95%)×25 min, Repetition of water-fine spray cycle
   Gloss after 500/1000 hrs (relative to initial value (%)), ΔE value measurement

As can be seen from Table 2 above, the physical properties of the highly weather resistant colored steel plate (WDP) were similar to those of conventional fluorine resin steel plates (PVDF).

It is evident from data of the obtained results that the physical properties of the zinc or zinc alloy-plated highly weather resistant colored steel plate (WDP) are excellent in terms of functional characteristics such as weather resistance and UV resistance, compared to those of conventional modified (RMP), highly weather resistant (HDP) and silicone-modified (SMP) colored steel plates. In addition, the highly weather resistant colored steel plate (WDP) is inexpensive relative to fluorine resin steel plates, has much less influence on the colors, and has physical properties equivalent to the fluorine resin steel plates.

Although the preferred embodiments of the present invention have been limited to the zinc-plated steel plates, those skilled in the art will appreciate that various modifications of the steel plates are possible and are construed to be embraced within the scope of the present invention.

1. A highly weather resistant colored steel plate, comprising:
a steel plate 1 as a substrate;
a zinc- or zinc alloy-plated layer 2 formed on the steel plate 1;
a layer 3 formed on the zinc- or zinc alloy-plated layer 2 and pretreated with chromate or non-chromate; and
a highly weather resistant film 10 formed on the chromate or non-chromate layer 3,
wherein the highly weather resistant film 10 includes a polyester-based primer 4 coated onto the chromate or non-chromate layer 3 and a polyester top coat 5 coated onto the polyester-based primer 4, the top coat 5 being produced from a mixture of a main resin obtained by reacting an oil-free polyester-modified resin and a polyisocyanate compound, a melamine resin as a crosslinking agent, and other additives.

2. The highly weather resistant colored steel plate according to claim 1, wherein the oil-free polyester-modified resin polyester resin has a number average molecular weight of 1,000-9,000, a glass transition temperature (Tg) of −5-45° C. and an OH number of 15-150.

3. The highly weather resistant colored steel plate according to claim 1, wherein the polyisocyanate compound is present in an amount of 5-30 parts by weight, based on the solid of the main resin.

4. The highly weather resistant colored steel plate according to claim 1, wherein the melamine resin is present in an amount of 4-10 parts by weight, based on the total weight of the top coat S.

5. The highly weather resistant colored steel plate according to any one of claims 1 to 4, wherein the pretreated layer 3 has a density of 20˜80 mg/m², the polyester-based primer 4 has a dry film thickness (D.F.T) of 4-7 μm, and the polyester top coat 5 has a dry film thickness (D.F.T) of 15-22 μm.

6. A method for manufacturing a highly weather resistant colored steel plate, comprising the steps of:
coating chromate or non-chromate onto a zinc- or zinc alloy-plated layer 2 at a line speed of 60˜120 mpm, and drying the chromate or non-chromate layer at 60˜140° C. to form a pretreated layer 3; and
forming a polyester-based primer 4, roll coating a polyester top coat 5 including a main resin obtained by reacting an oil-free polyester-modified resin and a polyisocyanate compound, a melamine resin as a crosslinking agent, and other additives, onto the polyester-based primer 4, and heating and drying the roll coated structure at a PMT of 190-240′ to form a highly weather resistant film 10.
